(19) United States
(12) Patent Application Publication
(10) Pub. No.: US 2011/0153170 A1
(43) Pub. Date: Jun. 23, 2011

(54) System And Method For Controlling An Implement To Maximize Machine Productivity And Protect a Final Grade

(75) Inventors: Eric J. Dishman, Peoria, IL (US); Erik J. Eddington, Bartonville, IL (US); Steven R. Krause, Chillicothe, IL (US); Wayne A. Lamb, Chillicothe, IL (US); Ryan A. Kingdon, El Paso, IL (US); Nathaniel S. Doy, Morton, IL (US)

(73) Assignee: Caterpillar Inc., Peoria, IL (US)

(21) Appl. No.: 12/645,599

(22) Filed: Dec. 23, 2009

(51) Int. Cl. G06F 7/00

(52) U.S. Cl. 701/50

(57) ABSTRACT

The disclosure describes, in one aspect, an implement control system including a controller operatively connected to an implement. The controller is adapted to receive a first signal and a second signal from a system in operative communication with the implement. The first signal is indicative of a desired load control condition and the second signal is indicative of a desired grade control condition. The controller is further adapted to determine a first target position having a first comparable characteristic associated with the first signal and to determine a second target position having a second comparable characteristic associated with the second signal. The controller is also adapted to generate a control signal to move the implement to the first target position or to the second target position based in part on the first comparable characteristic and the second comparable characteristic.

### TECHNICAL FIELD

This patent disclosure relates generally to an implement control system, and more particularly to systems and methods for controlling an implement to maximize machine productivity and protect a final grade.

### BACKGROUND

Earthmoving machines such as track type tractors, motor graders, scrapers, and/or backhoe loaders, have an implement such as a dozer blade or bucket, which is used on a worksite in order to alter a geography or terrain of a section of earth. The implement may be controlled by an operator or by a control system to perform work on the worksite. For example, the operator may move a lever that controls the movement of the implement through hydraulic mechanisms. To achieve a final surface contour or a final grade, the implement may be adjusted to various positions by the operator or the control system.

Positioning the implement, however, is a complex and time-consuming task that requires expert skill and diligence if the operator is controlling the movement. Thus, it is often desirable to provide autonomous control of the blade to simplify operator control. Prior art systems that automatically control the implement are known. For example, U.S. Pat. No. 5,560,431 issued to Stratton (“hereinafter '431”) discloses an apparatus and method for automatically controlling the position of an earthmoving implement of an earthmoving machine in response to varying ground profiles.

It is sometimes desirable, however, to utilize the skill of the operator by allowing the operator to primarily control the movement of the implement and to enhance the operator's productivity by providing a limiting function by the control system. Nevertheless, '431 and other prior art systems do not include systems that provide operator assistance by taking control of the implement during the majority of a typical dozer cycle. Such a system would reduce operator fatigue and reduce the number of operators and/or machines needed on bulk earthmoving worksites.

The disclosed systems and methods are directed to overcoming one or more of the problems set forth above.

### SUMMARY

In one aspect, the disclosure describes, in one aspect, an implement control system including a controller operatively connected to an implement. The controller is adapted to receive a first signal and a second signal from a system in operative communication with the implement. The first signal is indicative of a desired load control condition and the second signal is indicative of a desired grade control condition. The controller is further adapted to determine a first target position having a first comparable characteristic associated with the first signal and to determine a second target position having a second comparable characteristic associated with the second signal. The controller is also adapted to generate a control signal to move the implement to the first target position or to the second target position based in part on the first comparable characteristic and the second comparable characteristic.

The disclosure describes, in another aspect, a method for controlling an implement including receiving a first signal from a system operatively connected to the implement. The first signal is indicative of a desired load control condition. The method further includes receiving a second signal from the system. The second signal is indicative of a desired grade control condition. The method includes determining a first target position having a first comparable characteristic associated with the first signal and determining a second target position having a second comparable characteristic associated with the second signal. The method further includes generating a control signal to move the implement to the first target position or to the second target position based in part on the first comparable characteristic and the second comparable characteristic.

### BRIEF DESCRIPTION OF THE DRAWING(S)

FIG. 1 illustrates a machine having a implement control system in accordance with an exemplary embodiment of the present disclosure.

FIG. 2 illustrates a implement control system in accordance with an exemplary embodiment of the present disclosure.

FIG. 3 is a flow diagram illustrating one embodiment of an implement control process in accordance with an exemplary embodiment of the present disclosure.

### DETAILED DESCRIPTION

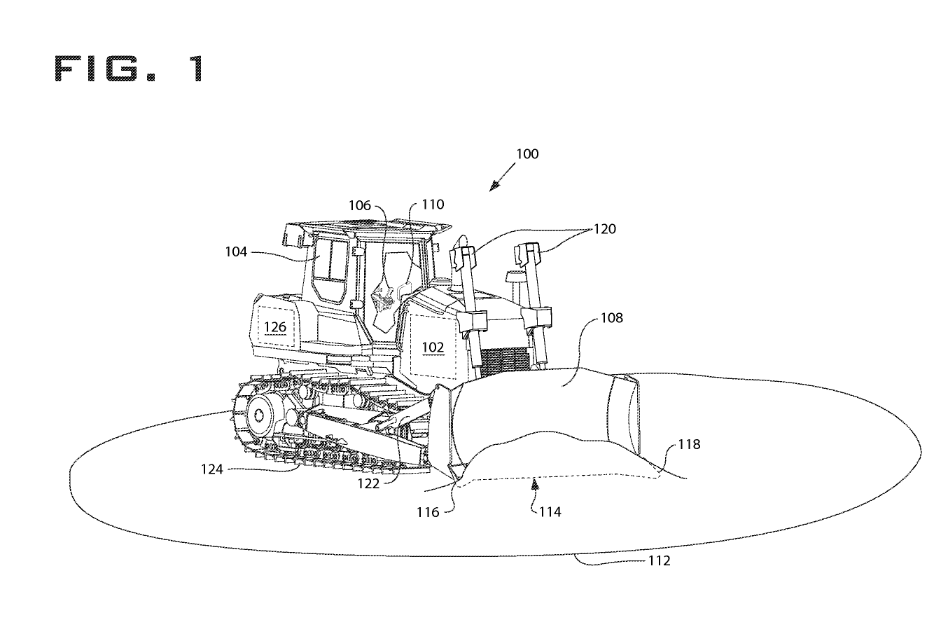

This disclosure relates to systems and methods for controlling an implement to maximize machine productivity and to protect final grade. An exemplary embodiment of a machine 100 is shown schematically in FIG. 1. The machine 100 may be a mobile machine that performs some type of operation associated with an industry such as mining, construction, farming, transportation, or any other industry known in the art. For example, the machine 100 may be a tractor or dozer, as depicted in FIG. 1, a motor grader, or any other machine known in the art. While the following detailed description of an exemplary embodiment describes the invention in connection with a dozer, it should be appreciated that the description applies equally to the use of the invention in other such machines. The present invention is not limited to use on a tractor or dozer.

In an illustrated embodiment, the machine 100 includes a power source 102, an operator's station or cab 104 containing controls necessary to operate the machine 100, such as, for example, one or more input devices 106 for propelling the machine 100 and/or controlling other machine components. The machine 100 further includes a work tool or implement 108, such as, for example, a blade for moving earth. The one or more input devices 106 may include one or more joysticks disposed within the cab 104 and may be adapted to receive input from an operator indicative of a desired movement of the implement 108.

For simplification purposes, only one input device 106 embodied as a joystick will be discussed and shown in the figures. The cab 104 may also include a user interface 110 having a display for conveying information to the operator and may include a keyboard, touch screen, or any suitable mechanism for receiving input from the operator to control and/or operate the machine 100, the implement 108, and/or the other machine components.

The implement 108 may be adapted to engage, penetrate, or cut the surface of a worksite 112 and may be further adapted to move the earth to accomplish a predetermined task. The worksite 112 may include, for example, a mine site, a landfill, a quarry, a construction site, or any other type of worksite. Moving the earth may be associated with altering the geography at the worksite 112 and may include, for example, a grading operation, a scraping operation, a leveling operation, a bulk material removal operation, or any other type of geography altering operation at the worksite 112.

In the illustrated embodiment, the implement 108 includes a cutting edge 114 that extends between a first end 116 and a second end 118. The first end 116 of the cutting edge 114 of the implement 108 may represent a right tip or right edge of the implement 108 and the second end 118 of the cutting edge 114 of the implement 108 may represent a left tip or left edge of the implement 108. The implement 108 may be moveable by one or more hydraulic mechanisms operatively connected to the input device 106 in the cab 104.

The hydraulic mechanisms may include one or more hydraulic lift actuators 120 and one or more hydraulic tilt actuators 122 for moving the implement 108 in various positions, such as, for example, lifting the implement 108 up or lowering the implement 108 down, tilting the implement 108 left or right, or pitching the implement 108 forward or backward. In the illustrated embodiment, the machine 100 includes one hydraulic lift actuator 120 and one hydraulic tilt actuator 122 on each side of the implement 108. The illustrated embodiment shows two hydraulic lift actuators 120, but only one of the two hydraulic tilt actuators 122 is shown (only one side shown).

The power source 102 is an engine that provides power to a ground engaging mechanism 124 adapted to support, steer, and propel the machine 100. The power source 102 may embody an engine such as, for example, a diesel engine, a gasoline engine, a gaseous fuel-powered engine, or any other type of combustion engine known in the art. It is contemplated that the power source 102 may alternatively embody a non-combustion source of power (not shown) such as, for example, a fuel cell, a power storage device, or another suitable source of power. The power source 102 may produce a mechanical or electrical power output that may be converted to hydraulic power for providing power to the machine 100, the implement 108, and to other machine 100 components.

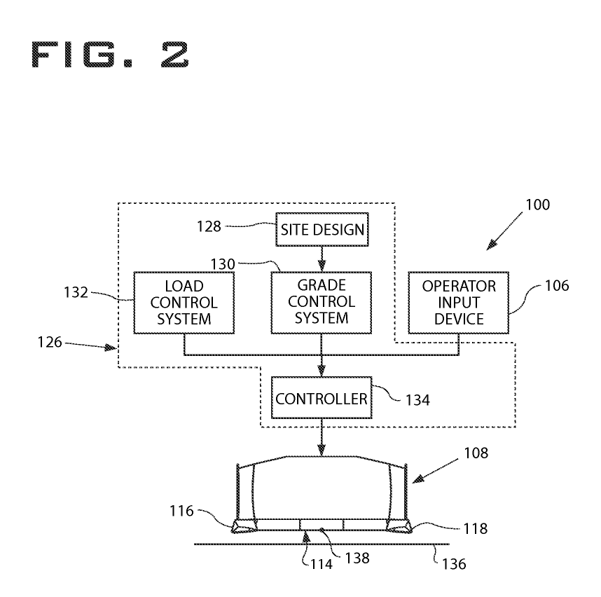

The machine 100 further includes an implement control system 126 operatively connected to the input device 106 and to the hydraulic actuators 120, 122 for controlling movement of the implement 108. As illustrated in FIG. 2, the implement control system 126 includes a site design 128, a grade control system 130, a load control system 132, and a controller 134. The controller 134 is adapted to receive inputs from the input device 106, the grade control system 130, and the load control system 134. The implement control system 126 is further adapted to control the movement of the implement 108 based on the inputs from the input device 106, the grade control system 130, and the load control system 134 individually or collectively in predetermined combinations.

The controller 134 may direct the implement 108 to move to a predetermined or target position in response to an input signal received from the input device 106 indicative of a position representing the operators' desired movement of the implement 108. The position signals indicative of the operators' desired movement of the implement 108 may include elevational signals, such as, for example, lower implement and raise implement signals. The position signals indicative of the operators' desired movement of the implement 108 may also include tilt signals, such as, for example, tilt left and tilt right signals.

In some embodiments, the tilt left and tilt right movements of the implement 108 may be accomplished by using the one or more input devices 106 to independently move the first end 116 of the cutting edge 114 or to independently move the second end 118 of the cutting edge 114. In some embodiments, moving the first end 116 may be accomplished by using one of the one or more input devices 106, such as, for example, using a right cylinder height lever (not shown), and moving the second end 118 may be accomplished by using another of the one or more input devices 106, such as, for example, using a left cylinder height lever (not shown). Alternatively, or additionally, moving the first end 116 and moving the second end 118 may be accomplished by using the same input device 106, embodied in a joystick as shown in the FIG. 1. Nevertheless, in other embodiments, the position signals do not include tilt signals.

The controller 134 may further direct the implement 108 to move to a predetermined or target position in response to an input signal received from the grade control system 130 that is indicative of an automatically determined movement of the implement 108. The automatically determined movement of the implement may be based on input from the site design 128. The position signals indicative of the automatic movement of the implement 108 also include elevational signals, such as, for example, lower implement and raise implement. The position signals indicative of the automatic movement of the implement 108 may or may not include tilt signals, such as, for example, tilt left or tilt right signals associated with tilt left and tilt right movements, as is discussed in detail above.

The site design 128 includes data related to the construction surface of the worksite based on an engineering design. The construction surface provided in the site design 128 may represent a ground profile that can be indicative of an irregular three-dimension (3D) surface or a flat plane. In the illustrated embodiment, the construction surface is a design plane 136 that represents the desired cutting plane or the desired final grade for the worksite 112.

In some embodiments, the grade control system 130 may be adapted to determine a relative location or position of the machine 100 within the worksite 112. In other embodiments, the grade control system 130 may be adapted to determine a relative location or position of the implement 108 based on the location or position of the machine 100 within the worksite 112. The relative location or position of the machine 100 and/or the implement 108 may be determined using one or more position sensors, GPS receivers, and/or laser systems, which are well-known in the art.

In the illustrated embodiment, the grade control system 130 receives input from the site design 128 indicative of the design plane 136 for the worksite 112 and determines the corresponding target position of the implement 108 relative to the design plane 136. The controller 134 receives an input from the grade control system 130 indicative of the target position generated by the grade control system 130 based on the relative position of the implement 108 to the design plane 136. The target position represents the position of the implement 108 required to engage the implement 108 with the terrain of the worksite 112 to achieve the design plane 136.

The controller 134 alternatively, or additionally, may direct the implement 108 to move to a predetermined or target position in response to an input signal received from the load control system 132 that is indicative of an automatically determined movement of the implement 108 based on a predetermined productivity value. The productivity value may correspond with a predetermined ground speed that represents maximum or optimal productivity. The productivity value may also correspond with a predetermined slip value that represents maximum or optimal productivity.

In some embodiments, the controller compares a current ground speed or current slip condition to a reference ground speed or reference slip condition commensurate with maximum or optimal productivity, determines the target position of the implement 108 necessary to maintain the ground speed or slip condition approximately equal to the reference ground speed or slip condition, and consequently directs the implement to move to the target position.

The controller 134 may also receive an input from the input device 106 indicative of the operator's desired position of the implement 108 for engaging the implement 108 with the terrain of the worksite 112. The controller 134 is adapted to receive the target position signal generated by the grade control system 130 and the target position signal generated by the input device 106 and to generate a control signal to move the implement 108 to the corresponding grade control system 130 target position or to the corresponding input device 106 target position based on the relative position of the implement 108 to the design plane 136. The control signal to move the implement 108 may be applied to actuate the hydraulic actuators 118, 120 to move the implement 108 to the corresponding target position. Moving the implement 108 may include a cut to the corresponding target position or a lift to the corresponding target position.

The controller 134 may be adapted to evaluate the relative position of the implement 108 and the design plane 136 by comparing the relative location of a portion of the cutting edge 114 of the implement 108 to the design plane 136. In the illustrated embodiment, the portion of the cutting edge 114 is disposed at about the center 138 of the cutting edge 114 of the implement 108 between the first end 116 and the second end 118. The controller 134 may determine whether the portion 134 is above the design plane 136 or below the design plane 136. The controller 134 may be adapted to determine whether to control the movement of the implement 108 based on the inputs from the input device 106 or based on the inputs from the grade control system 130 depending on whether the center 138 is above or below the design plane 136.

In other embodiments, the controller 134 may be adapted to evaluate the relative position of the implement 108 and the design plane 136 by comparing the relative location of a plurality of portions of the cutting edge 114 of the implement to the design plane 136. The plurality of the portions of the cutting edge 114 may include the portion disposed at about the center 138 of the cutting edge 114 and the portions of the cutting edge 114 disposed at about the first end 116 and/or at about the second end 118.

The controller 134 may be adapted to determine whether to control the movement of the implement 108 based on the inputs from the input device 106, based on the inputs from the grade control system 130, or based on the inputs from the load control system 132 depending on whether the center 138 is above or below the design plane 136 and/or depending on whether the first and second ends 116, 118 are above or below the design plane 136.

### INDUSTRIAL APPLICABILITY

The industrial applicability of the systems and methods for controlling an implement to maximize machine productivity and to protect final grade described herein will be readily appreciated from the foregoing discussion. Although the machine is shown as track-type tractor, the machine may be any type of machine that performs at least one operation associated with for example mining, construction, and other industrial applications. Moreover, the systems and methods described herein can be adapted to a large variety of machines and tasks. For example, backhoe loaders, skid steer loaders, wheel loaders, motor graders, and many other machines can benefit from the systems and methods described.

In accordance with certain embodiments, the implement control system 126 is adapted to compare the target position signal generated by the grade control system 130, the target position generated by the load control system 132, and the target position signal generated by the input device 106 and generates a control signal to move the implement 108 to the corresponding grade control system 130 target position, to the corresponding load control system 132 target position, or to the corresponding input device 106 target position based in part on the relative position of the implement 108 to the design plane 136. The implement control system 126 combines the grade control system 130 and the load control system 132 and combines them into an integrated system that provides an operator assisted control system that operates during all phases of a typical dozing cycle.

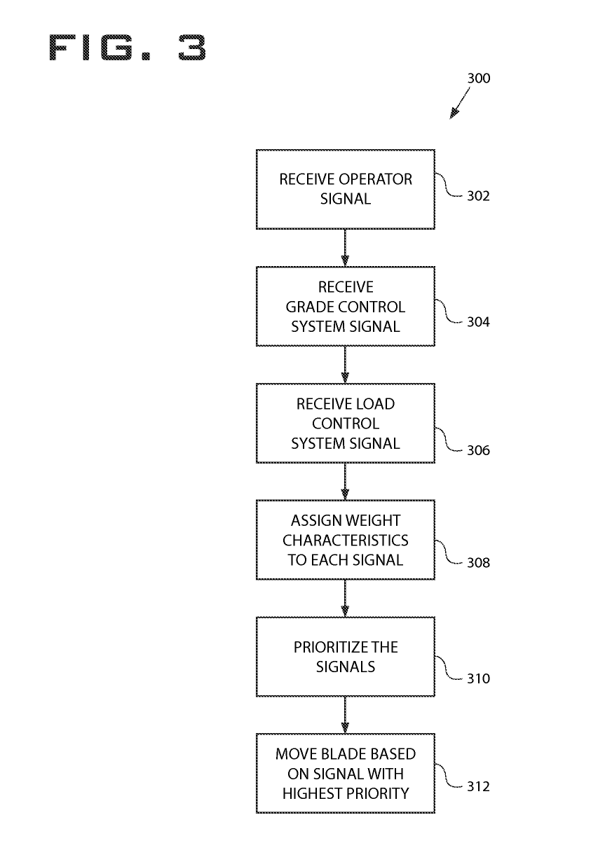

FIG. 3 illustrates an exemplary embodiment of the implement control process and the operation of the implement control system 126 (300). The controller 134 is adapted to receive the target position signal generated by the input device 106 indicative of the operator's desired position of the implement 108 (Step 302). The controller 134 is further adapted to receive a grade control condition signal generated by the grade control system 130 indicative of, for example, the position of the implement 108 required to engage the terrain of the worksite 112 to achieve the design plane 136 (Step 304). The controller 134 is further adapted to receive a load control condition signal generated by the load control system 132 indicative of, for example, the position of the implement 108 required to engage the terrain of the worksite 112 to achieve the maximum productivity (Step 306).

The controller 134 assigns a first comparable characteristic to the grade control condition signal, a second comparable characteristic to the load control condition signal, and a third comparable characteristic to the input device 106 target position signal (Step 308). The comparable characteristics may be comparable values or weights used to assign priority to one comparable characteristic relative to the other comparable characteristics, and consequently to assign relative priority to the associated signals. For example, if the first comparable characteristic is assigned a weight having a higher relative numerical value than the second comparable characteristic and the third comparable characteristic, the first comparable characteristic is considered to have the highest priority relative to the second and third comparable characteristics.

In some embodiments, the comparable characteristic may result from a normalization algorithm implemented by the grade control system 130, the load control system 132, or the controller 134, which transforms, for example, different input signal types into a common signal associated with the different input signal types. Logical and mathematical operations may be performed on the common signal types to compare the signals, prioritize the signals, and control the operation of the implement 108 based on the signal with the highest priority. For example, the grade control condition signal, the load control condition signal, and the input device 106 target position signal may each be normalized to represent a target position associated with each signal.

The target positions may represent positions of the implement 108 relative to the design plane 136. The target positions may also represent different positions relative to each other. The target position, for example, representing the greatest distance above the design plane 136 may be determined to have the highest priority, in which case the target position has an intrinsic or inherent comparable characteristic associated with each signal. Thus, in some embodiments, the controller 134 may compare the intrinsic or inherent comparable characteristics that are associated with the signals and in other embodiments the controller 134 may assign the comparable characteristic to be associated with each signal to prioritize the signals.

In the illustrated embodiment, the controller 134 assigns the first comparable characteristic to the grade control system 130 target position signal based in part on input from the site design 128. The controller 134 also assigns the second comparable characteristic to the load control system 132 target position signal based in part on comparing the ground speed of the machine 100 or the slip condition of the machine 100 to the predetermined reference ground speed or slip condition, which are indicative of an acceptable machine productivity.

The controller 134 assigns the third comparable characteristic to the input device 106 target position signal based in part on the relative position of the implement 108 to the design plane 136. In some embodiments, the controller 134 determines whether the input device 106 target position signal represents a relative position below the design plane 136 or above the design plane 136. If the relative input device 106 target position signal is above the design plane 136, the controller 134 may use the input device 106 target position signal to move the implement 108 to the target position indicative of the operator's desired position. If the relative input device 106 target position signal is below the design plane 136, for example, the controller 134 may use the grade control system 130 target position signal to move the implement 108 to the target position indicative of the desired grade condition, that is, if the first comparable characteristic has a higher priority than the second comparable characteristic.

The controller 134 is adapted to compare the first, second, and third comparable characteristics of the input device 106 target position signal, the grade control system 130 target position signal, and the load control system 132 target position signal and to prioritize between the signals based on the relative value of the comparable characteristics (Step 310). In some embodiments, the prioritization of the comparable characteristics may be based on an operating cycle of the machine 100. The machine 100 may be adapted to know what operating cycle the machine 100 is in based on, for example, at least one of an implement position relative to the machine 100, or the implement position relative to a previous implement position, or a command or signal provided by the operator indicative of the operating cycle, or any other known ways of determining the operating cycle.

For example, if the machine 100 is in an earth cutting or digging cycle, the controller 134 may assign a numerical value to represent the first comparable characteristic having a higher priority relative to the numerical values the controller assigns to represent the second and the third comparable characteristics. Alternatively, or additionally, if the machine 100 is in an earth moving or carrying cycle, the controller 134 may, for example, assign a numerical value to represent the second comparable characteristic having the highest priority relative to the first and third comparable characteristics.

In some embodiments, the prioritization of the first, second, and third comparable characteristics may be based on, for example, an operating condition of the machine 100. For example, the controller 134 may assign the highest numerical value to represent the first, second, or third comparable characteristic to have the highest relative priority when the corresponding target position of the first, second, or third comparable characteristic leads to increased productivity, to the desired grade, or to the operator's desired position.

The controller 134 moves the implement 108 to the position corresponding to the relative target position signal with the highest priority (Step 312). In other words, if the first comparable characterization has a higher priority than the second and third characterizations, then the controller 134 will move the implement 108 to the position corresponding to the input device 106 target position signal. Alternatively, or additionally, if the controller 134 does not receive a signal from the input device 106, for example, if the operator does not engage the input device 106 to indicate a desired target position, then the controller 134 may use the grade control system 130 target position signal or the load control system 132 target position signal to move the implement 108 to the corresponding position based in part on the relative values of the comparable characteristics associated with the grade control system 130 target position signal and with the load control system 132 target position signal.

Alternatively, or additionally, the controller 134 may be adapted to perform a logical or mathematical operation on the grade control system 130 target position, the load control system 132 target position, and the input device 106 target position and to determine a target position based in part on the result of the logical or mathematical operation. The controller 134 may move the implement 108 to the corresponding target position. For example, the controller 134 may determine a target position based in part on the summation of the grade control system 130 target position, the load control system 132 target position, and the input device 106 target position and may move the implement 108 to the corresponding target position.

In other embodiments, the controller 134 may determine a target position based in part on a statistical average of the grade control system 130 target position, the load control system 132 target position, and the input device 106 target position and may move the implement 108 to the corresponding target position.

The grade control system 130, the load control system 132, and the controller 134 may include one or more control modules (e.g. ECMs, ECUs, etc.). The one or more control modules may include processing units, memory, sensor interfaces, and/or control signal interfaces (for receiving and transmitting signals). The processing units may represent one or more logic and/or processing components used by the implement control system 126 to perform certain communications, control, and/or diagnostic functions. For example, the processing units may be adapted to execute routing information among devices within and/or external to the implement control system 126.

Further, the processing units may be adapted to execute instructions, including from a storage device, such as memory. The one or more control modules may include a plurality of processing units, such as one or more general purpose processing units and or special purpose units (for example, ASICS, FPGAs, etc.). In certain embodiments, functionality of the processing unit may be embodied within an integrated microprocessor or microcontroller, including integrated CPU, memory, and one or more peripherals. The memory may represent one or more known systems capable of storing information, including, but not limited to, a random access memory (RAM), a read-only memory (ROM), magnetic and optical storage devices, disks, programmable, erasable components such as erasable programmable read-only memory (EPROM, EEPROM, etc.), and nonvolatile memory such as flash memory.

It will be appreciated that the foregoing description provides examples of the disclosed systems and methods. However, it is contemplated that other implementations of the disclosure may differ in detail from the foregoing examples. All references to the disclosure or examples thereof are intended to reference the particular example being discussed at that point and are not intended to imply any limitation as to the scope of the disclosure more generally. All language of distinction and disparagement with respect to certain features is intended to indicate a lack of preference for those features, but not to exclude such from the scope of the disclosure entirely unless otherwise indicated.

Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context.

Accordingly, this disclosure includes all modifications and equivalents of the subject matter recited in the claims appended hereto as permitted by applicable law. Moreover, any combination of the above-described elements in all possible variations thereof is encompassed by the disclosure unless otherwise indicated herein or otherwise clearly contradicted by context.

We claim:

1. An implement control system, comprising:
a controller operatively connected to an implement, the controller adapted to:
receive a first signal and a second signal from a system in operative communication with the implement, wherein the first signal is indicative of a desired load control condition and the second signal is indicative of a desired grade control condition;
determine a first target position having a first comparable characteristic associated with the first signal, and determine a second target position having a second comparable characteristic associated with the second signal; and
generate a control signal to move the implement to the first target position or the second target position based in part on the first comparable characteristic and the second comparable characteristic.

2. The implement control system of claim 1, wherein the controller is further adapted to:
move the implement to the first target position and the second target position based in part on the first comparable characteristic and the second comparable characteristic.

3. The implement control system of claim 2, wherein the controller is further adapted to:
compare the first comparable characteristic and the second comparable characteristic to determine whether the first or the second comparable characteristic has the highest priority; and
move the implement to the first target position if the first comparable characteristic has the highest priority and to the second target position if the second comparable characteristic has the highest priority.

4. The implement control system of claim 1, wherein the controller is further adapted to:
receive a third signal indicative of an operator desired movement of the implement;
determine a third target position having a third comparable characteristic associated with the third signal; and
generate a control signal to move the implement to the first, second, and third target positions based in part on the first, the second, and the third comparable characteristics.

5. The implement control system of claim 4, wherein the controller is further adapted to:
compare the third comparable characteristic to the first and second comparable characteristics to determine if the first, the second, or the third comparable characteristic has the highest priority; and
move the implement to the third target position if the third comparable characteristic has the highest priority.

6. The implement control system of claim 4, wherein the controller is further adapted to:
determine a fourth target position based in part on a summation of the first, the second, and third target positions; and
generate a control signal to move the implement to the fourth target position.

7. The implement control system of claim 4, wherein the controller is further adapted to:
determine a fourth target position based in part on an average of the first, the second, and third target positions; and
generate a control signal to move the implement to the fourth target position.

8. The implement control system of claim 4, wherein the controller is further adapted to:
assign the first comparable characteristics to the first target position, the second comparable characteristics to the second target position, and the third comparable characteristics to the third target position.

9. The implement control system of claim 1, wherein the load control condition is based in part on a productivity level.

10. The implement control system of claim 9, wherein the productivity level is based in part on ground speed.

11. A method for controlling an implement, the method comprising:
receiving a first signal from a system operatively connected to the implement, wherein the first signal is indicative of a desired load control condition;
receiving a second signal from the system, wherein the second signal is indicative of a desired grade control condition;
determining a first target position having a first comparable characteristic associated with the first signal;
determining a second target position having a second comparable characteristic associated with the second signal; and
generating a control signal to move the implement to the first target position or the second target position based in part on the first comparable characteristic and the second comparable characteristic.

12. The method of claim 11, the method further comprising:
moving the implement to the first target position and the second target position based in part on the first comparable characteristic and the second comparable characteristic.

13. The method of claim 12, the method further comprising:
comparing the first comparable characteristic and the second comparable characteristic;
determining whether the first comparable characteristic or the second comparable characteristic has the highest priority; and
moving the implement to the first target position if the first comparable characteristic has the highest priority and to the second target position if the second comparable characteristic has the highest priority.

14. The method of claim 11, the method further comprising:
receiving a third signal from the system, wherein the third signal is indicative of a an operator desired movement of the implement;
determining a third target position having a third comparable characteristic associated with the third signal; and
generating a control signal to move the implement to the first, second, and third desired positions based in part on the first, the second, and the third comparable characteristics.

15. The method of claim 14, the method further comprising:
comparing the third comparable characteristic to the first and second comparable characteristics to determine if the first, second, or third comparable characteristic has the highest priority; and
moving the implement to the third target position if the third comparable characteristic has the highest priority.

16. The method of claim 14, the method further comprising:
assigning the first comparable characteristics to the first target position, the second comparable characteristics to the second target position, and the third comparable characteristics to the third target position.

17. The method of claim 11, wherein the load control condition is based in part on a productivity level.

18. The method of claim 16, wherein the productivity level is based in part on ground speed.

19. A machine, comprising:
an implement;
an implement control system operatively coupled to the implement, including a controller configured to:
receive a first signal and a second signal from a plurality of systems in operative communication with the control system, wherein the first signal is indicative of a desired load control condition and the second signal is indicative of a desired grade control condition;
determine a first target position based in part on the first signal;
assign a first comparable characteristic to the first target position, wherein the first comparable characteristic is associated with the first signal;
determine a second target position based in part on the second signal;
assign a second comparable characteristic to the second target position, wherein the second comparable characteristic is associated with the second signal;
compare the first comparable characteristic and the second characteristic to determine whether the first or the second comparable characteristic has the highest priority;
generate a control signal to move the implement to the first target position if the first comparable characteristic has the highest priority and to the second target position if the second comparable characteristic has the highest priority; and
move the implement to the first target position if the first comparable characteristic has the highest priority or to the second target position if the second comparable characteristic has the highest priority.

20. The machine of claim 19, wherein the controller of the implement control system is further configured to:
receive a third signal from the plurality of systems, wherein the third signal is indicative of an operator desired movement of the implement;
determine a third target position based in part on the third signal;
assign a third comparable characteristic to the third target position, wherein the third comparable characteristic is associated with the third signal;
compare the third comparable characteristic to the first and the second comparable characteristics to determine whether the first, the second, or the third comparable characteristic has the highest priority;
generate a control signal to move the implement to the third target position if the third comparable characteristic has the highest priority; and
move the implement to the third target position if the third comparable characteristic has the highest priority.
